(19) United States
(12) Patent Application Publication
(10) Pub. No.: US 2010/0092720 A1
(43) Pub. Date: Apr. 15, 2010

(54) Multi-Colored Two-Part Flocked Transfer and Method of Making and Process of Using the Same

(75) Inventor: Louis Brown Abrams, Fort Collins, CO (US)

Correspondence Address: SHERIDAN ROSS PC, 1560 BROADWAY, SUITE 1200, DENVER, CO, 80202, US

(73) Assignee: HIGH VOLTAGE GRAPHICS, INC., Fort Collins, CO (US)

(21) Appl. No.: 12/580,120

(22) Filed: Oct. 15, 2009

Related U.S. Application Data
(60) Provisional application No. 61/105,725, filed on Oct. 15, 2008.
(60) Provisional application No. 61/198,142, filed on Nov. 3, 2008.
(60) Provisional application No. 61/120,237, filed on Dec. 5, 2008.

(51) Int. Cl. B32B 33/00; B05D 1/16

(52) U.S. Cl. 428/90; 156/62.2

(57) ABSTRACT

The present invention relates generally to a multi-colored two-part decorative flocked article and to a method making and process of using the same.

### CROSS REFERENCE TO RELATED APPLICATIONS

The present application claims the benefit of U.S. Provisional Application Nos. 61/105,725, filed on Oct. 15, 2008, 61/198,142, filed on Nov. 3, 2008, and 61/120,237 filed on Dec. 5, 2008, each of which is incorporated in their entirety herein by this reference.

### FIELD OF INVENTION

This invention is directed generally to a two-part decorative flocked article and specifically to a method of making the multi-colored two-part decorative flocked article and a process of using the same.

### BACKGROUND

The following text should not be construed as an admission of knowledge in the prior art.

U.S. Pat. No. 4,810,549 to Abrams et al. discloses a method of creating of a multi-colored flocked transfer comprising a plurality of multi-colored flocked fibers positioned between an adhesive layer and a carrier sheet, the multi-colored flock fibers being adhered to the carrier sheet by a release adhesive. The multi-colored flocked transfer can be adhered a substrate by contacting the adhesive layer with the substrate and applying heat.

Another method for creating a multi-colored flocked transfer is a direct flocking process. The direct flocking process typically comprises applying flock to an adhesive previously applied to the substrate. A multi-colored flock transfer is formed by applying each color of the multi-color image in a separate direct flocking process. In the direct flocking process, each color is separately contacted with the previously applied adhesive, one color after another, until all the colors comprising the multi-color transfer have been applied.

Yet another method of creating a multi-colored flocked transfer on a substrate is applying a multi-colored flocked sticker to the substrate. The flock sticker typically comprises a plurality of multi-colored flock fibers, a liner paper, and a pressure-sensitive adhesive. The multi-colored flocked transfer is adhered to the substrate by the pressure sensitive adhesive.

For some multi-colored flocked designs the above methods do not produce satisfactory multi-colored flocked transfers. The direct flocking method is rife with problems. Basically, the direct flocking method is an inexact flocking method that results in fibers being located at many different angles and depths in the adhesive. Direct flocking typically produces flock transfers which “shed” fibers.

The level of detail achievable in a die-cut process limits the level of detail that can be achieved in the flock sticker method. More specifically, the level of detail is limited by the ability to remove or “weed” portions of the die-cut image that are to be discarded and not included in the final flocked image.

### SUMMARY OF THE INVENTION

An embodiment of the present invention is a process for making a flock transfer comprising positioning a release adhesive on a release sheet, contacting a plurality of flock fibers with the release adhesive to form a flock transfer; and indicating on the release sheet one or more registrable positions. The plurality of flock fibers has opposing first and second ends. The first ends are in contact with the release. The second ends of the flock fibers are fee of a permanent adhesive.

The plurality of flock fibers comprises two or more differing colors of flock fibers. The plurality of flock fibers forms one or more flock image shapes. Preferably, the one or more flocked images substantially resemble a desired flocked image. In a preferred embodiment, the one or more flocked images comprise sufficient flock to form the desired flocked image.

In another embodiment, the method for making the flock transfer further comprises indicating on the release sheet one or more registrable positions. In one configuration, the one or more registrable positions are determined relative to and after the printing the release adhesive. In another configuration, the one or more registrable positions are determined prior to and/or simultaneously with the printing of the release adhesive. In some instances, when the one or more registrable positions are determined prior to the printing of the release adhesive, the release adhesive is positioned on the release sheet relative to the one or more registrable positions.

Another embodiment of the present invention is a flock transfer made by one of the above described methods for making the same.

A preferred embodiment of the present invention is a method for making a flocked article, comprising receiving a flocked transfer sheet having one or more transfer sheet registrable positions indicated on the flocked transfer sheet, the flocked transfer sheet comprising a release adhesive positioned between flock fibers and a release sheet, and thereafter: indicating one or more substrate registrable positions on a substrate; positioning an adhesive on the substrate; registering at least one of the one or more flock transfer registrable positions with at least one of the one or more substrate registrable positions; and contacting the plurality of flock fibers with the adhesive, the flock fibers and the adhesive being in registrable.

Preferably, the plurality of flock fibers comprises two or more differing colors of flock fibers.

In a preferred embodiment, the adhesive is positioned on the substrate by a screen-printing process. In a more preferred embodiment, the adhesive is positioned in a form of one or more adhesive images. The flock fibers on the flock transfer form one or more flock images. In a preferred embodiment, the one or more flock images are contacted with the one or more adhesive images. Preferably, the one or more flock images have substantially enough flock to form a flock surface covering most, if not all, of the one or more adhesive images.

In another preferred embodiment, the adhesive is printed with a line width resolution of at least about 0.5 mills. In a more preferred embodiment, the adhesive is printed with a line width resolution of at least about 0.3 mils

The registering is selected from the group of registering methods consisting of mechanical registering methods, optical registering methods, and combinations thereof. In some embodiments, the indicating of the one or more substrate registrable positions on the substrate is conducted after and the positioning of the adhesive on the substrate and wherein the one or more substrate registrable positions are indicated on the substrate relative to the adhesive. In other embodiments, the positioning of the adhesive on the substrate is conducted after the indicating of the one or more substrate registrable positions on the substrate, preferably the adhesive is positioned on the substrate relative to the one or more substrate registrable positions.

In a preferred embodiment, the adhesive comprises a paste adhesive. Preferably, the paste adhesive comprises a water-based paste adhesive. That is, the water-based paste adhesive comprises water and at least one of a thermosetting adhesive, a thermoplastic adhesive, and/or a combination of thermosetting and thermoplastic adhesives. Preferably, after positioning the adhesive on the substrate, but before the contacting the flock fibers with the adhesive, the printed paste adhesive is modified by one or more of: i) removing at least some of the liquid from the paste adhesive; ii) heating the paste adhesive; iii) curing at least some of the paste adhesive; iv) thickening the paste adhesive; v) glazing the paste adhesive; and vi) contacting a viscosity modifier with the paste adhesive. In some embodiments, the adhesive is positioned on the substrate by a screen-printing process. It is preferred, but not required, that the adhesive positioned on substrate be maintained in a substantially dimensionally stable position for at least some of the period from the screen-printing process until adhering the textile element to the substrate.

In a preferred embodiment, the method further comprises after the contacting the flock fibers with the adhesive, adhering the flock fibers to the substrate. One or both of the contacting and adhering of the textile flock fibers to the substrate further comprises one or both of applying pressure and heat. During one or both of contacting and adhering steps, the flock fibers are at least partially embedded in the adhesive.

In another embodiment, the method for making a flocked article further comprises receiving an insert, registering at least one of the one or more insert registrable positions with at least one of the one or more substrate registrable positions, and positioning an insert surface adjacent to the substrate, the insert and the substrate being in registration. Preferably, the insert is positioned on the substrate prior to the contacting of the flock fibers with the adhesive. In one configuration, the flock fibers at least partially surround the perimeter of the insert.

The insert comprises one or more of: a woven textile material, a non-woven material, a metallic material, a polymeric material, a polyester material, and a satin material. In one embodiment, the insert further comprises an insert adhesive positioned on the insert surface positioned adjacent to the substrate. In one configuration, the insert is adhered to substrate by the insert adhesive. In another configuration, the insert is adhered to the substrate by the adhesive.

Another embodiment of the present invention is an article made by one of the above described methods for making the same.

Additional advantages of the present invention will become readily apparent from the following discussion, particularly when taken together with the accompanying drawings.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 depicts a process for making a flock transfer according to an embodiment of the present invention;

FIG. 2 depicts a process for making a flocked article according to an embodiment of the present invention;

FIG. 3 depicts a cross-sectional view of a flock transfer according to an embodiment of the present invention;

FIG. 4 depicts a top elevation view of the flock transfer of FIG. 3;

FIG. 5 depicts a top elevation view of a flocked article according to an embodiment of the present invention;

FIG. 6 depicts a cross-sectional view of the flocked article of FIG. 5;

FIG. 7A depicts a flocked article make according to another embodiment of the present invention;

FIG. 7B depicts a flocked article made according to yet another embodiment of the present invention;

FIG. 8 depicts a top elevation view of a flocked article according to yet another embodiment of the present invention; and

FIG. 9 depicts a cross-sectional view of the flocked article of FIG. 8.

### DETAILED DESCRIPTION OF THE INVENTION

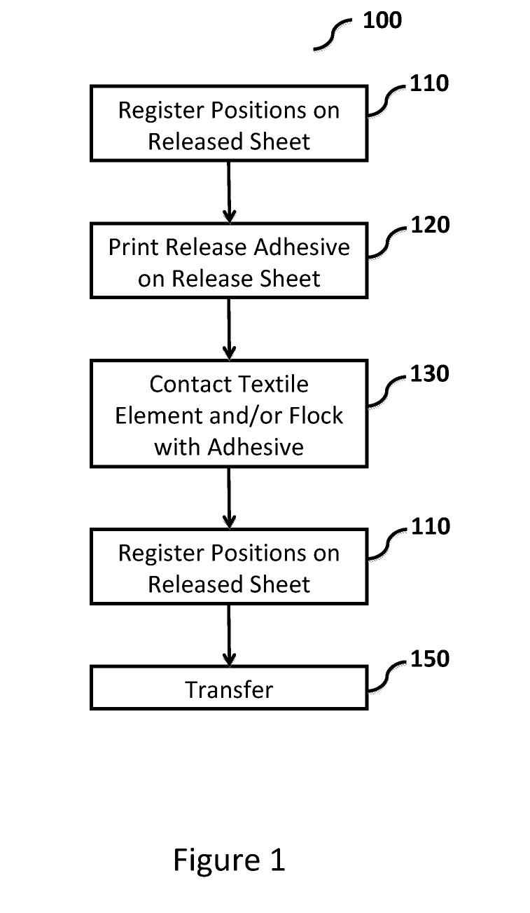

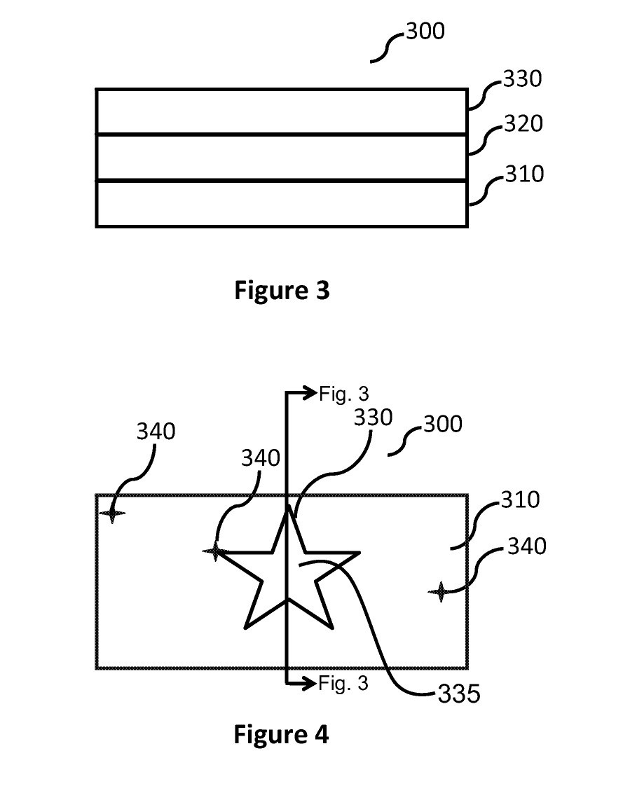

Process 100 for making a flock transfer 300 is depicted in FIG. 1. The flock transfer 300 comprises a release adhesive 320 positioned between a plurality of flock fibers 330 and a release sheet 310, as depicted in FIGS. 3 and 4. In one preferred embodiment, the flock fibers form a flock image 335 positioned on the release sheet 310, the flock image 335 is positioned relative to one or more flock transfer registrable positions 340.

The flock fibers can be any natural or synthetic material. The synthetic material can include vinyl, rayons, nylons, polyamides, polyesters, polyester terephthalates, polyethylene terephthalates), poly(cyclohexylene-dimethylene terephthalates), acrylic, and natural materials (such as cotton and wool), Preferably, the flock fibers comprise one of rayon, nylon, polyamides, polyester, polyethylene terephthalate) and poly(cyclohexylene-dimethylene terephthalate). In some instances, a conductive coating or finish can be applied continuously or discontinuously over the exterior surface of the flock fibers 330 to permit the flock fibers 330 to hold an electrical charge.

The flock fibers can be colored. The colored flock fibers can be pre-colored or sublimation printed. Sublimation printing involves vapor phase transportation a dye into the flock fibers, preferably along the entire length of the flock fibers. In a preferred embodiment, the plurality of flock fibers 330 can comprise a plurality of differing colored flock fibers. In a preferred embodiment, the plurality of flock fibers 330 comprises two or more differing colors of flock fibers.

The release sheet 310 can be any substrate that is dimensionally stable under the conditions of temperature and pressure encountered during the process. The release sheet 310 can be any low-cost, dimensionally stable substrate, such as paper, plastic film, a porous film, and the like in the form of a discontinuous sheet or a running web line material. Preferably, the release sheet is in a discontinuous form and/or a porous film. A preferred porous film is further discussed in U.S. Pat. No. 6,025,068 to Pekala, which is incorporated in its entirety hereby by this reference. A particularly preferred porous film is sold by PPG Industries Inc. under the trade name TESLIN™. In some instances, battery separator membranes can also be used as the release sheet 310. Examples of suitable battery separator membranes include without limitation battery separator membranes sold by Celgard or by Daramic, Inc., as for example, battery separator membranes sold under the tradenames or Daramic Industrial CL™ and Artisyn™. Artisyn™ is an uncoated, nono-layer, highly filled polyolefin sheet.

The release adhesive 320 can be any adhesive that adheres more strongly to the release sheet than the flock fibers, but adheres to both enough to hold them together. The release adhesive can be in the form of one of a paste, a liquid, an emulsion, and/or dispersion. For example, the release adhesive 320 can be any temporary adhesive, such as a resin or a copolymer, e.g., a polyvinyl acetate, polyvinyl alcohol, polyvinyl chloride, polyvinyl butyral, acrylic resin, polyurethane, polyester, polyamides, cellulose derivatives, rubber derivatives, starch, casein, dextrin, gum arabic, carboxymethyl cellulose, rosin, silicone, or compositions containing two or more of these ingredients.

In step 120, the release adhesive 320 is applied to the release sheet 310 prior to and/or after registering (step 110) the one or more flock transfer registrable positions 340 on the release sheet 310. The release adhesive 320 can be applied to the release sheet 310 by a printing process, such as, but not limited to printing (such as, screen-printing, pad printing, flexographic, lithographic, and gravure), spray and/or roller processes. In a preferred embodiment, the release adhesive 320 is screen-printed on the release sheet 310. The release adhesive 320 can be applied to release sheet 310 in the form of a solution or emulsion. The release adhesive 320 may be applied on the release sheet 310 in the shape of the desired design or without regard to the overall design desired. In one preferred embodiment, the release adhesive 320 is printed on the release sheet 310 to substantially represent a desired final flock image in size, shape and color scheme. Preferably, the desired final flock image can be a graphical design image having a desired graphical image color scheme. In some configurations, the desired final flock image can be a graphical design image having a desired graphical image color scheme that includes one or more random sub-graphical images which can include one or more substantially and/or partially random color schemes.

In one embodiment, the registering of the one or more flock transfer registrable positions 340 on the flocked transfer 300 is conducted prior to, during and/or substantially simultaneous with the applying release adhesive 320 to the release sheet 310. In such an instance, the registration is substantially precise and/or accurate to precisely and/or accurately position the release adhesive 320 on the release sheet 310 relative to the one or more flock transfer registrable positions 340.

In another embodiment, the release adhesive 320 is applied to the release sheet 310 prior to the registering the one or more flock transfer registrable positions 340 on the flocked transfer 300. That is, the one or more flock transfer registrable positions 340 are registered on the flocked transfer 300 (such as, but not limited to on the release sheet 310) after applying the release adhesive 320 to the release sheet 310. That is, the registering of the one or more registration flock transfer registrable positions 340 (step 110) can be before, during and/or after the printing the release adhesive 320. In some instances, the registering of the one or more registrable positions 340 (step 110) can be after contacting the plurality of flock fibers 330 with the release adhesive 320. Preferably, step 110 is preformed once during process 100. More preferably, step 110 is performed once before one of the following: before step 120, after step 120 but before step 130, and/or after step 130.

The one or more flock transfer registrable positions 340 registered in step 110 can be permanent, semi-permanent, or virtual designations on the flock transfer 300. Non-limiting examples of registrable position designators are: symbols printed on the release sheet 310, symbols embossed (including voids and/or cut-outs) on the release sheet 310, and/or positions calculated with respect to the release sheet 310 (such as, triangulated relative to release sheet 310) and/or the plurality of flock fibers 330 and/or release adhesive 320 positioned on the release sheet 300.

The release sheet can be supplied with the one or more flock transfer registrable positions 340 designated on the release sheet 310 and/or the one or more flock transfer registrable positions 340 can be designated during the step 110.

When the registering process is conducted after the printing of the release adhesive in step 120, the one or more flock transfer registrable positions 340 can be registered relative to the position of one or both of the release adhesive 320 and/or the plurality of flock fibers 330.

The one or more flock transfer registrable positions 340 can be determined in step 110 by mechanical and/or optical methods. One non-limiting example of a mechanical registration method is a mechanical jig with one or more stops. Non-limiting examples of optical registration methods are laser light positioning and optical identification, preferably controlled by a computer. A non-limiting example of an optical/mechanical method is a machine vision device controlled and/or operated by a computer.

Changes in temperature and/or humidity can affect the registration process and positioning of release adhesive 320 on the release sheet 310. For this reason, the release sheet 310 and/or release adhesive 320 should preferably be substantially dimensionally stable under operational conditions, such as, but not limited to operational temperatures and/or humidities.

In step 130, the plurality of flock fibers 330 are contacted with the release adhesive 320 to form the flock transfer 300. In some instances, one color of the differing flock fibers colors after another are contacted with the release adhesive 320, until all of the differing colored flock fibers are contacted with the release adhesive 320. The plurality of flock fibers 330 are contacted with the release adhesive 320 using known techniques, such as, electrostatic and gravity flocking techniques. It is desired that at least most of the plurality of flock fibers 330 are orthogonal or perpendicular to the release sheet 310. The contacting of the plurality of flock fibers 330 with the release adhesive 310 further discussed in U.S. Pat. Nos. 7,344,769, 7,364,782, 7,402,222, 7,381,284, and 7,390,552 all to Abrams, each of which is incorporated in its entirety wherewith by this reference.

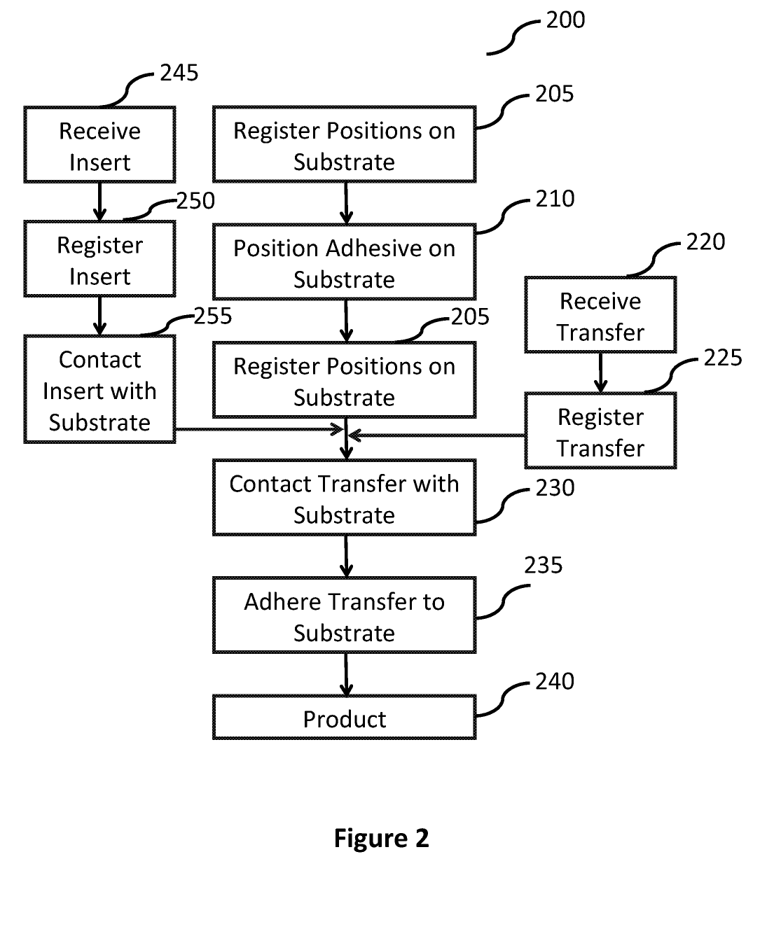

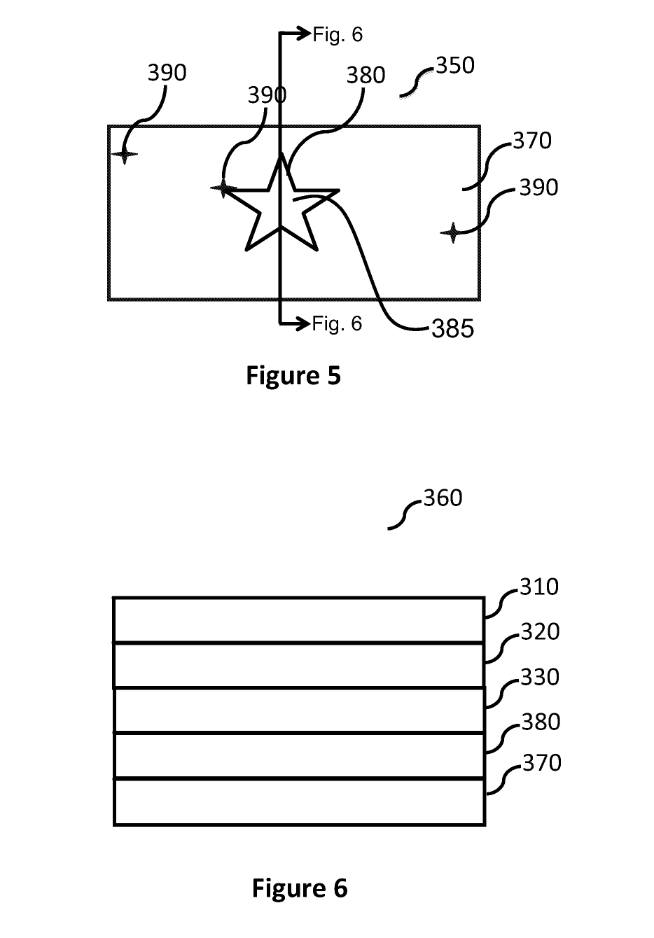

In step 150, the flock transfer 300 is supplied to process 200. FIG. 2 depicts a process for making a flocked article 350 after receiving the flock transfer 300. FIG. 5 depicts a top elevation view of a flocked article according to one embodiment, and FIG. 6 depicts a cross-sectional view of the flocked article of FIG. 5.

In step 220, the flock transfer 300 is received. The flock transfer 300 can be received sequentially from step 130, optionally from step 140 or the flock transfer 300 can be received from another source (such as, but not limited to a supplier or vendor of flock transfers).

In step 210, an adhesive 380 is applied to the substrate 370. As in the case of applying the release adhesive 320 to the release sheet 310, the adhesive 380 can be applied to the substrate prior to, during, and/or after registering one or more substrate registrable positions 390 on substrate 370 (step 205).

In one embodiment, the registering of the one or more substrate registrable positions 390 on the substrate 370 (that is, step 205) is conducted prior to and/or substantially simultaneous with the applying the adhesive 380 to the substrate 370. In such an instance, the registration is substantially precise and/or accurate to precisely and/or accurately apply the adhesive 380 to the substrate 370 relative to the one or more substrate registrable positions 390. In one embodiment, the precision and/or accuracy of the registration method substantially aids in accurately and/or precisely applying freestanding fine lines of the adhesive 380 on the substrate 370.

In step 205, one or more substrate registrable positions 380 are registered on substrate 370. The one or more substrate registrable positions 380 can be permanent, semi-permanent, or virtual designations on the substrate 370. The registrable position designators on the substrate 370 can be: symbols printed on the substrate 370, elements of substrate 370 (such as, but not limited to profile or structural elements), elements permanently or reversibly attached to the substrate 370, and/or positions calculated with respect to the substrate 370 (such as, triangulated relative to substrate 370) and/or with respect to the adhesive 380 applied to the substrate 370 and/or combinations thereof. The substrate 370 can be supplied with the one or more substrate registrable positions 390 designated on the substrate 370 and/or the one or more substrate registrable positions 390 can be designated on the substrate 370 during the registration process.

Preferably, step 205 is preformed once during process 200. More preferably, step 205 is performed once before one of the following: before step 210, after step 210 but before step 255, and/or after step 210 but before step 230.

The substrate 370 can be any material, such as, without limitation: polymeric; metallic; textile (woven or non-woven); paper; plastic; organic (wooden, cellulosic, leather, fibrous, etc.); polymeric (including homopolymers, heteropolymers, polymeric blends and alloys, and mixtures thereof); paper; paperboard, cardboard, ceramic; and inorganic (glass, mineral, etc.). Preferred substrates 370 are textile, plastic, polymeric, and organic materials.

When the adhesive 380 is positioned on the substrate 370 prior to the registering of the one or more substrate registrable positions 390 on the substrate 370, the one or more substrate registrable positions 390 are registered on the substrate 370 after the positioning of the adhesive 380 on the substrate 370. In such an instance, the one or more substrate registrable positions 390 can be registered relative to the position of the adhesive 380 positioned on substrate 370.

The registering of the one or more substrate registrable positions 390 is conducted similarly to the registering of the one or more flock transfer registrable positions 340. That is, the methods for registering the one or more substrate registrable positions 390 are substantially similar to the methods for registering the one or more flock transfer registrable positions 340. Similarly the one or more substrate registrable positions 390 can be permanent, semi-permanent, or virtual designations on the substrate 370. It can be appreciated that, registrable position designations the release sheet 310 and the substrate 370 means any thing, respectively, position on and/or within the release sheet 310 and/or substrate 370.

Returning to the adhesive 380, the adhesive 380 can be applied to the substrate 370 by any printing process, such as, but not limited to printing (such as, screen-printing, pad printing, flexographic, lithographic, and gravure), spray and/or roller processes. Preferably, the adhesive 380 is applied to the substrate 370 in a printing process. More preferably, the adhesive 380 is applied to the substrate 370 in screen-printing process. The adhesive 380 is printed to form one or more adhesive images 385. Preferably, the one or more adhesive images substantially resemble the desired, final flocked image on the flocked product 360. The desired, final flock image can comprise one or flocked images.

Non-limiting examples of suitable adhesives 380 are: pressure sensitive adhesives, hot-melt thermoplastic adhesives, A- and/or B-staged thermosetting adhesives, solvent based adhesive mixtures (including organic and non-organic solvents, and water), adhesive slurries, dispersed liquid adhesives, dispersed solid adhesives, adhesive particles, or combinations thereof. In a preferred embodiment, the adhesive 380 is a heat sensitive adhesive comprising fine adhesive particles.

The adhesive 380 can be a water-based and/or solvent-based adhesive. Furthermore, the adhesive 380 can be in the form of a liquid, solid, powder and/or paste. The adhesive 380 can comprise without limitation one or more of: epoxies, phenoformaldehydes, polyvinyl butyrals, cyanoacrylates, polyethylenes, isobutylenes, rubber-based adhesives (styrene copolymers, including without limitation styrene-isoprene-styrene, styrene-butadiene-styrene, and copolymers thereof), silicones, non-crosslinked rubber based latexes, acrylics (acrylics, methacrylates, ethylene ethyl acrylates, ethylene methyl acrylates, and co-polymers thereof), polyurethane, polyamides, polyvinyl acetates, latexes, chloroprenes, butyls, polybutadienes, isoprenes, neoprenes, and polyesters, and can exhibit thermoplastic and/or thermosetting behavior.

The screen-printable adhesive can be a thermoplastic adhesive and/or a material that has thermoplastic properties after being heated, such as after being at least partially dried and/or heat cured. Preferably, one or both of heat and pressure activates the adhesive 380.

The adhesive 380 can be the form of a solution, an emulsion and/or a paste. In an embodiment, the adhesive 380 is a paste adhesive. In preferred embodiment, the adhesive 380 is a screen-printable paste adhesive. In a more preferred embodiment, the paste adhesive comprises a water-based paste adhesive. In an even more preferred embodiment, the water-based paste adhesive comprises water and at least one of a thermosetting adhesive, a thermoplastic adhesive, and/or a combination of thermosetting and thermoplastic adhesives.

The adhesive 380 can be printed as freestanding, fine lines of the adhesive 380. The freestanding, fine lines of the adhesive 380 can have a line width resolution of at least about 0.5 mils. In a more preferred embodiment, the adhesive 380 can be printed as freestanding fine lines having a line width resolution of at least about 0.3 mils.

In an even more preferred embodiment, freestanding, fine lines of the adhesive 380 comprise the paste adhesive. The fine lines of the paste adhesive spread and/or broaden less, that is, have a greater line resolution than fine lines of printed liquid and/or adhesive emulsions of the prior art. While not wanting to bound by any theory, the liquid adhesives and/or adhesive emulsions of the prior art have at least one of a lower viscosity and/or a lower surface tension than the paste adhesive. Therefore, the liquid adhesives and/or adhesive emulsion spread and/or broaden after being printed. The paste adhesive can have at least a substantially greater viscosity than liquid adhesives and/or adhesive emulsions and, therefore, fine printed lines of the paste adhesive substantially spread and/or broaden less than fine printed lines of the liquid adhesives and/or adhesive emulsions.

Furthermore, the printing of higher resolution fine lines of the adhesive 380 can be affected by the substrate 370. While not wanting to be bound by any theory, finer lines and/or higher resolution can be obtained by printing the adhesive 380 on smoother and/or higher energy substrates. The printed fine lines of the adhesive 380 can have a lesser tendency to broaden and/or spread on smoother and/or higher energy surfaces. More specifically, the printed fines of the paste adhesive can have a lesser tendency to broaden and/or spread on smoother and/or higher energy surfaces than liquid adhesives and/or adhesive emulsions.

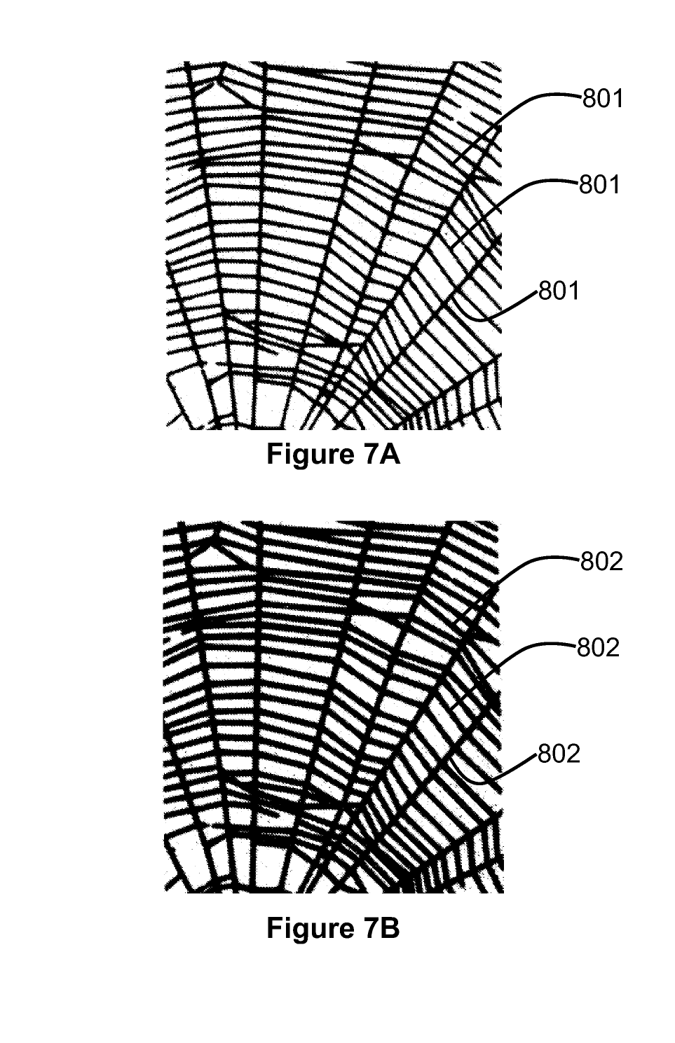

The ability to print freestanding fines lines of the paste adhesive allows for flocked article design features previously unattainable by the prior art methods, such as, thin, narrow, delicate design features previously unattainable by the methods of the prior art flock transfer methods. While not wanting to be limited by example, freestanding fine lines of the paste adhesive allows for fine line designs, such as, but not limited to, the fine line design depicted in FIG. 7A. FIG. 7A depicts a flocked design formed by printing freestanding, fine lines of the paste adhesive on a cardboard substrate and applying flock fibers to the printed paste adhesive, the resolution of the flocked fiber design lines 801 being about 0.2 to about 0.4 mils. FIG. 7B depicts the same flocked formed by printing an adhesive on a flocked surface of a flock transfer sheet. The flocks and substrates of FIGS. 7A and 7B are the same. Furthermore, the same printing screen was used to print the same paste adhesive. The difference between FIGS. 7A and 7B being the substrate onto which the paste adhesive is printed. In FIG. 7A, the paste adhesive is printed on a (cardboard) substrate where the adhesive spreads and broadens little, if any. In FIG. 7B, the paste adhesive is printed on a substrate (a flocked surface) where the adhesive can spread and broaden. The resolution of the flocked fiber web line 802 of FIG. 7B is form about 0.6 to about 0.8 mils.

In some embodiments, the screen-printable paste adhesive 380 is printed on partially porous and/or roughened substrate, such as, a fabric, the paste adhesive is preferably at least partly pushed into the substrate 370. While the adhesive 380 is at least partly pushing into the substrate 370, it is preferred that at least some of the adhesive 380 extends upward from the substrate 370 surface. Preferably, the adhesive 380 positioned on the substrate 370 forms a relatively uniform profile of the adhesive 380 extending upward from the substrate 370 surface. More preferably, the adhesive 380 forms a relatively uniformly flat profile of the adhesive 380 extending upward from the substrate 370 surface. While not wanting to be bound by theory, the relatively uniform adhesive profile is preferred for subsequent contacting with the flock transfer 300.

The adhesive 380 can be printed on the substrate 370 in the form of an adhesive image 385 (FIG. 7). Preferably, the adhesive image 385 is substantially about the same shape and size as the flock transfer image 335. More preferably, the flock transfer image 335 is at least larger than the adhesive image 385. The at least larger flock transfer image 335 substantially assures that at least all of the adhesive image 385 is contacted with flock.

In one embodiment, the substrate 370 is maintained on the screen-printing machine pallet after applying the adhesive 380 to the substrate 370 in a substantially undisturbed condition to form a substantially dry adhesive. A substantially undisturbed condition means the screen-printed adhesive substantially maintains its position relative to the one or more substrate registrable positions 390 throughout the drying process. That is, the screen-printed image 385 is substantially about the same size, shape and position relative to the one or more substrate registrable positions 390 prior to and after the drying process. In one embodiment, when the substrate 370 is a deformable substrate (such as, a fabric), the substrate 370 is allowed to remain substantially undisturbed on the screen printing machine pallet during the drying process.

While not wanting to be bound by theory, a higher viscosity adhesive can secure at least most of plurality of the flock fibers 3330 to the substrate 370 to a greater extent than a lower viscosity adhesive. The flock fibers in contact with the adhesive are less likely to move and/or to be dislodged from the high viscosity adhesive 380 than from the lower viscosity adhesive 380. Additionally, the screen-printed higher viscosity adhesive 380 is less likely to change shape during one or more of drying, curing, and/or heat pressing compared to the lower viscosity adhesive 380.

In another embodiment, the viscosity of the adhesive 380 is increased by one or more of: a) the passage of time, wherein the adhesive 380 looses liquid and/or begins to dry; b) exposure to heat, wherein the rate of loss of water is accelerated; and/or c) chemical thickening of the adhesive 380, such as, but not limited to gelling agents, skin forming agents, or such. Care must be taken when increasing the viscosity of adhesive 380 by exposure to heat to not trap water inside of the drying adhesive. The trapping of water within the drying adhesive 380 can degrade one or more of the adhesive performance and cure.

In one embodiment, after applying the adhesive 380 to the substrate 370 the liquid in the adhesive 380 is ‘flashed’ off. The liquid can be ‘flashed off’ by a flash unit on the screen printing press. In some instances, the liquid is ‘flashed off’ by applying heat to the adhesive 380 after applying the adhesive 380 to the substrate 370.

In one embodiment, after printing the adhesive 380 on the substrate 370, the substrate 370 with the adhesive 380 is moved from the printing machine to a drier. Preferably, the substrate 370 with the adhesive 380 is moved from the printing machine to the drier in time period of less than about 3 seconds to about 30 minutes. More preferably, for productivity sake, the substrate 370 with the adhesive 380 printed thereupon is moved from the printing machine to the drier immediately after the adhesive 380 in printed on the substrate 370. The substrate 370 can be mounted on a flat surface (such as, but not limited to a board) to maintain dimensional stability during the manufacturing process from the contacting of the adhesive 380 with the substrate 370 to production of the final flocked article 360 in step 240. Preferably, the time period for the drying process ranges from about 1 minute to about 180 minutes. More preferably, the drying period is from about 10 minutes to about 100 minutes. In a preferred embodiment, substantially enough of the liquid is removed during the drying process to form a substantially dry adhesive film on the substrate 370. The dry adhesive film is substantially dry enough not to resist modification (that is, not be substantially removed and smudged) by routine handling. In a more preferred embodiment, the liquid being removed is the water contained with the water-based paste adhesive.

In a preferred embodiment, the liquid is removed in an air-drying process. In a more preferred embodiment, the liquid water contained within the paste is removed in an air-drying process. After printing the paste adhesive on the substrate 370, the screen-printed adhesive can air-dried at temperature from about ambient to about 175° F., preferably from about ambient to about 120° F. In another configuration, the paste adhesive can be dried using an air-exchange process. For example, in a room and/or cabinet, that removes the vaporized liquid water by the air exchange process. In more preferred configuration, the paste adhesive is air-dried at a temperature from about ambient to about 120° F. in combination with an air-exchange process.

In another embodiment, substrate 370 with the adhesive 380 positioned thereupon is moved without substantial distortion to a drier belt for the optional drying step (not shown) after step 210. Preferably, the adhesive 280 is stabilized and substantially dried (or ‘finished’) during the drying step. The stabilizing and drying (or finishing) of the adhesive 380 prepares the adhesive 380 for contacting the flock transfer 300. After the drying the substrate 370 with the dried adhesive is moved without substantial distortion (that is, the dimensional stability of the substrate 370 and/or adhesive 380 are maintained during the move) to at least one of the contact 230 and adhering 240 steps. During the contacting step 230, one or both of heat and/or pressure can be applied to embed the plurality of flock fibers 330 into the adhesive 380.

In another embodiment, the viscosity of the adhesive 380 is increased by printing a glazing on the adhesive 380, a non-limiting example is described in U.S. application Ser. No. 11/413,797 with a filing date of Apr. 28, 2006, the entire contents of which is incorporated herein by this reference.

In step 225, the one or more flock transfer registrable positions 340 are determined. The one or more flock transfer registrable positions 340 and the one or more substrate registrable positions 390 are utilized to substantially align the flocked image 335 with the adhesive image 385.

In step 230, the flocked image 335 and the adhesive image 385 are contacted substantially in registration. That is, the one or more flock transfer registrable positions 340 and the one or more substrate registrable positions 390 are utilized in contacting the flock transfer 300 in substantial registration with the printed adhesive image 385 (step 130). Registering the one or more flock transfer registrable positions 340 and the one or more substrate registrable positions 390, one to the other, affords a higher quality artistic design manufacturing process than in the prior art manufacturing processes.

The registering of the one or more flock transfer registrable positions 340 and/or the one or more substrate registrable positions 390 can be affected by changes in temperature and/or humidity. For these reasons, one or both of the substrate 370 and the flock transfer 300 should be substantially dimensionally stable under operational conditions.

In step 230, at least most, if not all, of the plurality of flock fibers 330 are contacted with the adhesive 380. In a preferred embodiment, the flock transfer image 335 is at least lager than the adhesive image 385, therefore, not all of the plurality of flock fibers 330 are contacted with the adhesive in 380.

In step 235, at least most, if not all, of the flock fibers in contact with the adhesive 380 are adhered to the substrate 370 to form an article of manufacture 360. The plurality of flock fibers 330 are substantially adhered to the substrate by the adhesive 380. One or both of heat and pressure can be applied during one or both of the contacting and/or adhering of the flock transfer 300 to the substrate 370.

In a preferred embodiment, one or both of heat and pressure can be applied during the adhering step 235 to adhesively bind plurality of flock fibers 330 to the substrate 370. The heat can soften and/or partially melt the adhesive 380. The flock fibers ends in contact with the softened and/or partially melted adhesive 380 can be embedded in the softened and/or melted adhesive 380. After setting the adhesive 380 (that is, solidifying and/or cross-linking) the embedded flock fibers are substantially permanently adhered by the adhesive 380 to the substrate 370.

Returning to the drying of the adhesive 380, the substrate 370 can remain mounted on the flat, dimensionally stable surface during one or more of the contacting of the adhesive with the substrate (step 210), the registering of the one or more substrate registrable positions (step 210), the drying of the adhesive (not shown), the contacting (step 230), and adhering of the (step 235). In a preferred embodiment, the flat, dimensionally stable surface: a) supports the substrate 370 during the embedding of the flock fibers into the adhesive 380; and b) supports and/or restrains the substrate 370 in a dimensionally stable position during the adhesive registering of the one or more substrate registrable positions 390.

In another embodiment, the release sheet 310 along with the release adhesive 320 are removed after one of the adhering step 235, preferably after adhesive 380 has set (that is, after adhesive 380 has cooled to ambient temperature and/or cross-linked). The flock fibers with ends substantially embedded in the adhesive 380 remain after the release sheet 310 is removed, while the flock fibers that do not have an end substantially embedded in the adhesive 380 remain attached to release sheet 310.

In optional embodiment, the flocked article 360 includes an insert 400 having one or more insert registrable positions, the insert 400 registrable positions being similar to the transfer and/or substrate one or more registrable positions. The insert 400 can have an insert adhesive applied to one surface of the insert.

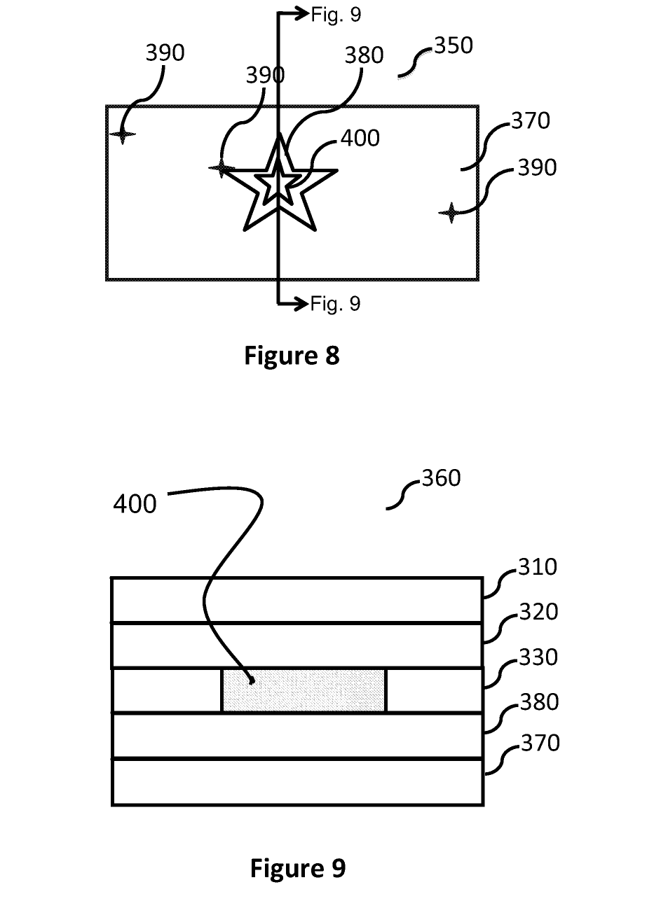

FIG. 8 depicts a top elevation view of a flocked article according to another embodiment, the flocked article having an insert, and FIG. 9 depicts a cross-section view of the flocked article of FIG. 8. Preferably, the flock fibers 330 at least partially surround the perimeter of the insert 400. In some embodiments, the perimeter of the insert 400 is not surrounded by the flock fibers 330. The greater resolution achieved with the freestanding, fine line printing of the paste adhesive allows for a tighter fit, that less, less of gap between the insert 400 and the flock fibers 330.

The insert 400 can comprise any material. Non-limiting examples of preferred insert materials are: metallics, textiles (woven or non-woven), papers, plastics, organics (wooden, cellulosic, leather, fibrous, etc.), polymers (including homopolymers, heteropolymers, polymeric blends and alloys, and mixtures thereof), ceramics, and inorganics (glass, mineral, etc.). The insert 400 can comprise a mixture of insert materials. In other embodiments, the insert can have at least one of: a substantially flat planar shape; a beaded-shape; a two-dimensional graphic image, alphanumeric, and/or artistic shape; and/or a three-dimensional graphic image, alphanumeric, and/or artistic shape.

In a preferred embodiment, the insert 400 comprises one of: a woven textile material, a non-woven material, a polymeric material, a polyester material, and a satin material. Exemplary woven textiles, including the woven inserts, include loosely or heavily woven polyesters with increased surface dimensionality or character, with or without an image, such as a sublimation dye printed image. In a preferred configuration the woven textile is a woven textile product sold under the trade name ObiTex™ by Fiberlok®, having an enhanced surface texture and luster that provides an embroidered or hand-stitched embroidered appearance. Preferably, the woven textile can contain an image on a first side of the woven textile. The image is typically comprises at least one of: a sublimation dye image; an embossed image; a woven image; or a combination thereof. A second adhesive can be positioned on a second side of the woven textile, the first and second sides being opposing sides. The second adhesive can be a hot-melt adhesive, preferably one of: a thermoplastic adhesive, a thermosetting adhesive, or a mixture thereof. The second adhesive can be activated by at least one of the heat and/or pressure. The activated second adhesive can adhere the woven insert to the substrate 270.

Preferably, the woven insert is pre-cut to the desired shape. More preferably, the woven insert is pre-cut, such as laser cut, to minimize fraying of the cut edges.

The insert 400 is received in step 245. In step 250, the one or more insert registrable positions are determined. The one or more insert registrable positions and the one or more substrate registrable positions 390 are utilized to substantially align the insert with the substrate 370. In step 255, the insert 400 and the substrate 370 are contacted in substantially in registration.

In a preferred embodiment, the insert adhesive is contacted with the substrate surface in step 255, the insert adhesive substantially adhering the insert 400 to the substrate 370. In another embodiment, the insert 400 can be contacted with at least some of the adhesive 380, preferably prior to contacting the plurality of flock fibers with the adhesive 380, the adhesive 380 substantially adhering the insert 400 and the plurality of flock fibers 330 to the substrate 310. The insert 400 and the plurality of flock fibers 330 are adhered to the substrate 370 in step 235.

In another optional embodiment, the flock transfer 300 can comprise a woven textile and can lack any flock fibers. In such an instance, the woven textile is registered with the adhesive 380 and contacted with the adhesive in registration. After contacting the adhesive 380 the woven textile is adhered to the substrate 370 in step 235 to produce the article of manufacture 360 in step 240.

In one embodiment, the transfer 300 is manufactured by first party and received by a second, unrelated party. The second party receives the transfer having one or more transfer registrable positions indicated on the transfer, the transfer comprising a release adhesive positioned between a textile element and a release sheet; and thereafter produces an article of manufacture by: indicating one or more substrate registrable positions on a substrate; positioning an adhesive on the substrate; registering at least one of the one or more transfer registrable positions with at least one of the one or more substrate registrable positions; and contacting the textile element with the adhesive, the textile element and the adhesive being in registration. The textile element can comprise one or more of: 1) a plurality of flock fibers; 2) a plurality of flock fibers having differing colors of flock fibers; 3) a plurality of fibers having an insert; and 4) a woven textile.

In another embodiment, a first party produces the insert 300 and a second party produces the adhesive 280 positioned on the substrate 270, the substrate having at least one or more substrate registrable positions. A third party receives the insert 300 and the substrate having the one or more substrate registrable positions with the adhesive positioned on the substrate, and produces an article so manufacture by contacting and adhering the insert to the substrate in registration.

The present invention, in various embodiments, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations, combinations, and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A process for making a flocked transfer, comprising:
positioning a release adhesive on a release sheet; and
adhering a plurality of flock fibers having opposing first and second ends, the first ends in contact with the release adhesive; and
indicating on the flocked transfer one or more registrable positions.

2. The process of claim 1, wherein the plurality of flock fibers comprises two or more differing colors of flock fibers.

3. The process of claim 4, wherein at least one of the following is true:
(i) the one or more registrable positions are determined relative to and after the printing the release adhesive; and
(ii) the one or more registrable positions are determined prior to the printing of the release adhesive.

4. The process of claim 3, wherein (ii) is true and wherein the printing of the release sheet includes positioning the release adhesive relative to the one or more registrable positions.

5. The process of claim 1, wherein the plurality of flock fibers forms one or more flock image shapes, and wherein and the second ends free of permanent adhesive.

6. A flock transfer made by the process of claim 1.

7. A method for making an article, comprising:
receiving a flocked transfer having one or more transfer sheet registrable positions indicated on the transfer sheet, the transfer sheet comprising a release adhesive positioned between flock fibers and a release sheet; and thereafter:
indicating one or more substrate registrable positions on a substrate;
positioning an adhesive on the substrate;
registering at least one of the one or more flock transfer registrable positions with at least one of the one or more substrate registrable positions; and
contacting the flock fibers with the adhesive, the textile element and the adhesive being in registration.

8. The method of claim 7, wherein the registering is selected from the group of registering methods consisting of mechanical registering methods, optical registering methods, and combinations thereof.

9. The method of claim 7, wherein the indicating of the one or more substrate registrable positions on the substrate is conducted after and the positioning of the adhesive on the substrate and wherein the one or more substrate registrable positions are indicated relative to the adhesive.

10. The method of claim 7, wherein the positioning of the adhesive on the substrate is conducted after the indicating of the one or more substrate registrable positions on the substrate and wherein the adhesive is positioned on the substrate relative to the one or more substrate registrable positions.

11. The method of claim 7, wherein the adhesive comprises a paste adhesive, wherein the paste adhesive comprises a water-based paste adhesive.

12. The method of claim 11, wherein the water-based paste adhesive comprises water and at least one of a thermosetting adhesive, a thermoplastic adhesive, and/or a combination of thermosetting and thermoplastic adhesives.

13. The method of claim 11, further comprising after positioning the adhesive but before the contacting the textile element with the adhesive:
modifying the paste adhesive by one or more of:
i) removing at least some of the liquid from the paste adhesive;
ii) heating the paste adhesive;
iii) curing at least some of the paste adhesive;
iv) thickening the paste adhesive;
v) glazing the paste adhesive; and
vi) contacting a viscosity modifier with the paste adhesive.

14. The method of claim 7, wherein the adhesive is positioned on the substrate by a screen-printing process, and wherein the adhesive is positioned on the substrate in form of one or more adhesive images.

15. The method of 14, wherein the adhesive is printed with a line width resolution of no greater than about 0.5 mills.

16. The method of claim 14, wherein the adhesive is printed with a line width resolution of no greater than about 0.3 mils.

17. The method of claim 11, wherein the adhesive positioned on substrate is maintained in a substantially dimensionally stable position for at least some of the period from the screen-printing process until adhering the textile element to the substrate.

18. The method of claim 7, further comprising:
adhering the flock fibers to the substrate.

19. The method of claim 7, wherein the contacting of the flock fibers with the adhesive further comprises one or both of applying pressure and heat and wherein the fibers are at least partially embedded at least partially in the adhesive.

20. The method of claim 7, wherein the flock fibers on the transfer form one or more flock images, wherein the printed adhesive forms one or more adhesive images, wherein the one or more flock images are contacted with the one or more adhesive images, and wherein the one or more flock images have substantially enough flock to form a flock surface covering most, if not all, of the one or more adhesive images.

21. The method of claim 7, wherein the adhesive is selected from the group of adhesives consisting of thermosetting adhesives, thermoplastic adhesives, or mixtures thereof.

22. The method of claim 7, wherein the plurality of flock fibers comprises two or more differing colors of flock fibers and wherein the flock fibers are at least partially embedded in the adhesive.

23. The method of claim 7, further comprising:
receiving an insert;
registering at least one of the one or more insert registrable positions with at least one of the one or more substrate registrable positions; and
positioning an insert surface adjacent to the substrate, the insert and the substrate being in registration.

24. The method of claim 23, wherein the insert comprises one or more of: a woven textile material, a non-woven material, a metallic material, a polymeric material, a polyester material, and a satin material, wherein the insert has the insert adhesive positioned on the insert surface positioned adjacent to the substrate, and wherein the insert is adhered to the substrate by the insert adhesive.

25. The method of claim 23, wherein the insert is adhered to the substrate by the adhesive.

26. The method of claim 23, wherein the insert is positioned on the substrate prior to the contacting of the flock fibers with the adhesive, and wherein the flock fibers at least partially surround the perimeter of the insert.

27. A flocked article make by the process of claim 7.
